(19) United States
(12) Patent Application Publication
(10) Pub. No.: US 2005/0137950 A1
(43) Pub. Date: Jun. 23, 2005

(54) Method and apparatus for a value framework and return on investment model

(75) Inventors: Gino Anthony Palozzi, Westerville, OH (US); Brian J. Scheld, Medfield, MA (US); Howard Young, Richmond Hill (CA); Brian Mitchell Zysfain, West New York, NJ (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/738,709

(22) Filed: Dec. 17, 2003

(51) Int. Cl. G06F 17/60

(52) U.S. Cl. 705/35

(57) ABSTRACT

A method and system for calculating the return-on-investments (ROI) for an enterprise architecture. The present invention discloses a unique set of metrics which provides improved accuracy for the economic and architecture for the construction of future systems. A preferred embodiment of the present invention focuses on developing process improvement assumptions associated with estimating the impact of the proposed capabilities. It includes the following components: an understanding of the client's strategic drivers, an understanding of the key business process areas, an identification of the business capabilities that a solution can offer the client, an estimation of the business processes improvements, and an estimation of the financial impact the proposed solution will have on the client. The value framework and ROI model of the present invention incorporates a client's strategic position and key processes before the benefits of a proposed solution or initiative can be estimated.

### BACKGROUND OF THE INVENTION

1. Technical Field

The present invention relates to an improved data processing system, and in particular to a method and system for providing a framework for using a data processing system to calculate the return-on-investments (ROI) for a proposed technical solution. The present invention provides a unique framework and discloses a unique set of calculations that provide the ability to quickly and accurately estimate the economic impact of a proposed solution.

2. Description of Related Art

The proliferation of information processing solutions available to a business enterprise has proven advantageous to most modern enterprises, providing an opportunity to apply the benefits of computer processing technology to most every area of the enterprise and accordingly to better service customers in a more efficient manner. In the late 1990s, information technology (IT) investments were driven by external factors, most notably the emergence of new competitive threats from companies and business models that grew out of the dot.com era. It was also during this period that the stock market was seeing unprecedented growth, creating an environment where capital was readily available and the traditional analysis and hurdles placed on potential investments often reduced in order to respond quickly to the changing marketplace. In recent years, the importance of analyzing the potential return and break-even period for potential investments has re-emerged. Business entities are now requiring a more disciplined assessment of proposed business initiatives. In order to stay competitive, a service provider must develop the ability to effectively communicate a compelling case for the estimated economic impact of the proposed services and solutions.

When a client seeks the services of an IT provider, the providers will often try to address the business needs of the clients by ‘leading with technology.’ In other words, service providers often approach a client engagement by touting the features and functionality of the proposed solutions. They start with the solution and then link the solution to the client's strategy. However, such an approach will often fail to specifically address a client's needs. All businesses measure financial performance in terms of revenues and cost. Estimating the business value of a proposed initiative is best communicated by estimating the impact on these key financial metrics.

Thus, a service provider must show that it is a trusted business advisor by justifying investments in proposed initiatives. This justification can be done by first understanding the client's strategic intent and linking those business drivers to the business capabilities that the proposed solution enables. In other words, the solution provider should start with the client's strategy and then design a solution that addresses the client's business needs.

Therefore, it would be advantageous to provide a framework for calculating the return-on-investments (ROI) that incorporates a client's strategic position and the key processes where improvements will enable the client to achieve its business objectives. Such an approach would require an understanding of the client's strategic intent, identifying the key process areas and the required business capabilities before the benefits of a proposed solution or initiative can be estimated.

From the foregoing it can be seen that a need exists for an approach and tool for calculating the financial benefits of a proposed solution to a client. The ideal solution assessment process emphasizes a process-improvement view and offers a structured approach for developing the quantitative benefits linked to these improvements. Therefore, it would be advantageous to enable the implementation of a series of assessment processes designed to incorporate a client's strategic position and key processes where improvements will enable the client to achieve its business objectives. Furthermore, it would be desirable to provide such a framework that allows service providers to present a consistent look and feel when working with clients and that is not solution or industry-specific.

### SUMMARY OF THE INVENTION

The present invention provides a method and system for calculating the return-on-investments (ROI) for a proposed technical solution. The present invention provides a unique framework and discloses a unique set of calculations that provide the ability to quickly and accurately estimate the economic impact of a proposed solution.

A preferred embodiment of the present invention focuses on developing process improvement assumptions associated with estimating the impact of the proposed capabilities. It includes the following main components: an understanding of the client's strategic drivers, an understanding of the key business process areas, an identification of the business capabilities that a solution can offer the client, an estimation of the business processes improvements, and an estimation of the financial impact the proposed solution will have on the client.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a data processing system in which the present invention may be implemented in accordance with a preferred embodiment of the present invention;

FIG. 2 is a block diagram of the major processing steps in accordance with a preferred embodiment of the present invention;

FIG. 3 is a diagram showing a high-level work breakdown in accordance with a preferred embodiment of the present invention;

FIG. 4 is a diagram showing an example of a business processes and key performance metrics (KPM) worksheet as generated by the return on investments (ROI) model in accordance with a preferred embodiment of the present invention;

FIG. 5 is a diagram showing an example of a capability worksheet as generated by the ROI model in accordance with a preferred embodiment of the present invention;

FIG. 6 is a diagram showing an example of a capability and process linkage worksheet as generated by the ROI model in accordance with a preferred embodiment of the present invention;

FIG. 7 is a sample output as generated by the ROI model showing the prioritization of the identified process impacts in accordance with a preferred embodiment of the present invention;

FIG. 8 is a diagram showing a seven-step approach for estimating process improvement in accordance with the present invention in accordance with a preferred embodiment of the present invention;

FIG. 9 is a chart showing a specific classification of benefits in accordance with a preferred embodiment of the present invention;

FIG. 10 is a diagram showing an example of estimated cost benefits as generated by the ROI model in accordance with a preferred embodiment of the present invention;

FIG. 11 is a diagram showing an example of a benefit summary as generated by the ROI model in accordance with a preferred embodiment of the present invention;

FIG. 12 is a diagram showing an example of benefits by initiative and category as generated by the ROI model in accordance with a preferred embodiment of the present invention;

FIG. 13 is a diagram showing an example of a required investment worksheet as generated by the ROI model in accordance with a preferred embodiment of the present invention;

FIG. 14 is a diagram showing an example of a cost benefit assessment by initiative as generated by the ROI model in accordance with a preferred embodiment of the present invention; and

FIG. 15 is a graph showing a break-even analysis as generated by the ROI model in accordance with a preferred embodiment of the present invention.

### DETAILED DESCRIPTION OF THE PREFERRED EMBODIMENT

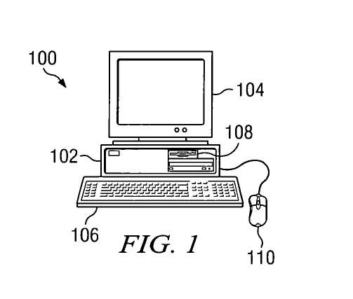

With reference now to the figures and in particular with reference to FIG. 1, a pictorial representation of a data processing system in which the present invention may be implemented is depicted in accordance with a preferred embodiment of the present invention. A computer 100 is depicted which includes a system unit 102, a video display terminal 104, a keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like.

Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

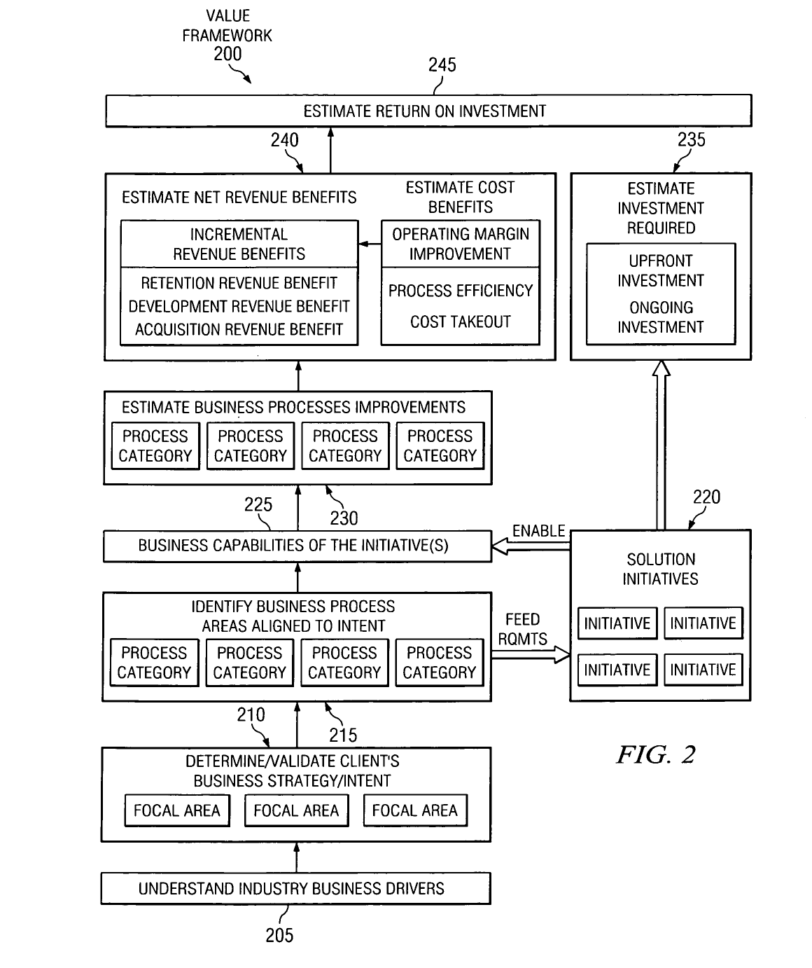

FIG. 2 illustrates an overview of the present invention. Value framework and ROI tool 200 may be utilized by traditional IT service providers. Value framework 200 of the present invention can assist client engagement teams in developing a client value proposition during proposal development by taking a process-improvement view to estimate the financial impact of a technology solution. Value framework and ROI tool 200 may be implemented in a data processing system, such as computer 100 as described in FIG. 1. Each element of the required data is input into a data collection tool located in the data processing system, such as, for example, a Microsoft Excel spreadsheet. The data is processed according to value framework 200 and displayed as shown in FIG. 2.

There are five main components in creating value framework 200 of the preferred embodiment of the present invention. As stated above, required data for each component is input into a data collection tool located in a data processing system. The first component in creating a value proposition requires that the value model team understand the industry business (strategic) drivers (steps 205 and 210). The second component in creating a value proposition requires that the team understand the key business process areas (step 215). The third component identifies the business capabilities that technology can offer the client (step 225). The fourth component estimates the business processes improvements and links proposed solutions to the business benefits that they can provide (step 230). The fifth component estimates financial impact the proposed solution will have on the client (steps 240 and 245).

The value framework and ROI model of the present invention incorporates a client's strategic position and key processes before the benefits of a proposed solution or initiative can be estimated. A program such as Microsoft Excel may be utilized for developing the ROI model. Microsoft Excel is available from Microsoft Corporation. The ROI model uses the value framework structure, proven financial principles, and UNIQUE mathematical formulas to generate the value proposition output. The Excel workbook provides the user/practitioner with an explicit step-by-step approach for populating the required data. In addition, the model may provide multiple investment views, including the internal rate of return by line of business, by initiative, and by the overall organization.

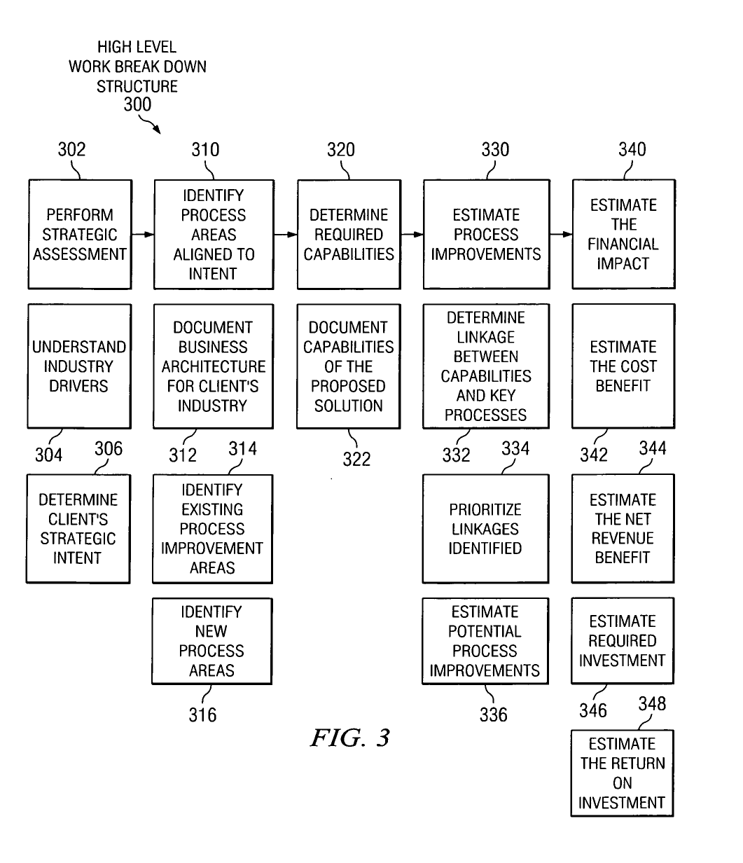

The flow diagram in FIG. 3 illustrates a high-level work breakdown structure 300 in accordance with a preferred embodiment of the present invention. This representation will serve as an overview upon which details of each stage of the process provided in FIG. 2 will be understood. Initially, a strategic assessment 302 must be performed. This assessment includes generating an understanding of the industry drivers 304 and determining the client's strategic intent 306. Industry drivers are factors and trends that drive a client's industry. A client's strategic intent is comprised of the client's business objectives. Next, business process areas aligned to intent must be identified 310. These business process areas are key process areas where improvements would deliver benefits that align to a client's business objectives. The identification includes documenting business architecture for the client's industry 312, identifying existing process improvement areas 314, and identifying new process areas 316. Thereafter, required capabilities of the proposed technology must be determined 320. This determination includes documenting the capabilities of the proposed solution 322. Next, the impact of process improvements must be estimated 330. This includes determining linkages between technology capabilities and key processes 332, prioritizing the identified linkages 334, and estimating potential process improvements 336. Finally, the financial impact of the solution must be estimated 340. This includes estimating the cost benefit 342, the net revenue benefit 344, the required investment 346, and the return on investment 348.

Referring back to FIG. 2, step 205 is the initial step in creating a value proposition and entails generating an understanding the industry business drivers. When a service provider initially engages a client, the service provider must understand the trends and factors that drive the client's industry. However, it is also critical that the service provider understand how the client is positioned relative to its industry and peers. Determining industry trends is a logical starting point for a service provider engaging a client needing to comprehend its competitive position, its weaknesses, and ultimately its strategic intent.

Next, in step 210, an understanding of the client's business or strategic intent is formed based upon the understanding of the industry's business drivers. The determination of a client's strategic intent often involves a structured strategic engagement and may be outside of the scope of the service provider's value assessment operations. However, this determination is necessary to determine the areas of business that the client should focus on and is required input for developing the value proposition in accordance with the present invention. The strategic assessment work necessary to clarify the client's business objectives can be performed by the service provider, a third party firm, or by the client itself. Regardless of who performs the assessment, understanding the client's business objectives is critical when positioning a proposed solution and developing a value proposition that communicates the potential benefits in terms of the business objectives identified.

Once the client's strategic intent has been determined or validated, an identification of the key process areas where improvements would deliver benefits that align to its business objectives can be performed in step 215. This step of identifying and documenting a client's key business processes and sub-processes is performed in preparation for a client-sponsored workshop. Identifying the key business processes aligned to the client's intent includes understanding the business architecture or process view for the client's industry, determining existing processes where improvements would result in desired results, and identifying new processes that could facilitate achieving desired results. Understanding and having access to process diagrams of the business architecture for the client's industry will speed up the development of the value proposition. The value of a process diagram increases if there is documentation provided on how the different technology solutions the service provider offers the client's industry impact the various processes.

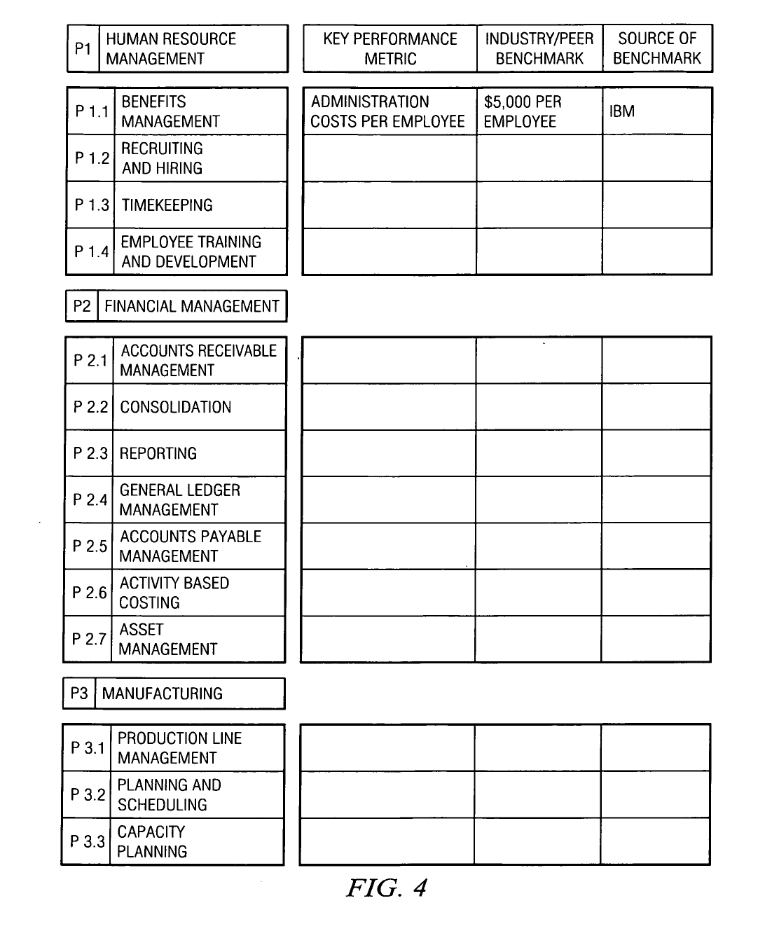

Turning now to FIG. 4, a closer look at the function of the key performance metrics (KPMs) and industry benchmarks utilized in step 215 in FIG. 2 is provided. Once the key process areas and new process areas have been determined, the KPMs, industry/peer benchmarks, and source of the benchmark data for each of the sub-processes must be documented. FIG. 4 provides an example of how the ROI model captures the process areas, sub-processes, KPMs, benchmarks, and the data source. As shown in the example, the ROI model may be developed using a program, such as Microsoft Excel, and displayed in worksheet form. The ROI model uses the value framework structure, proven financial principles, and UNIQUE mathematical formulas to generate the value proposition output. The Excel workbook provides the user with an explicit step-by-step approach for populating the required data. However, determining the appropriate KPMs and documenting the benchmark data can be very time consuming. Similar to the industry process diagrams, if the metrics and benchmark data is readily available, the time required to develop the value proposition can be significantly shortened.

Turning back to FIG. 2, after the business process areas are identified in step 215, proposed initiatives developed in step 220 are used for estimating business process improvements that the proposed solution can provide in step 225. A critical aspect of linking a proposed solution to the business benefits that they can provide is communicating how the capabilities that the solution delivers enable process improvements. The capabilities that the proposed solution enables should first be documented in terms of new or enhanced business capabilities. These capabilities will often be technical in nature, but may also include capabilities that result from improved competency and knowledge in a certain area or proposed changes to the organizational model and governance systems.

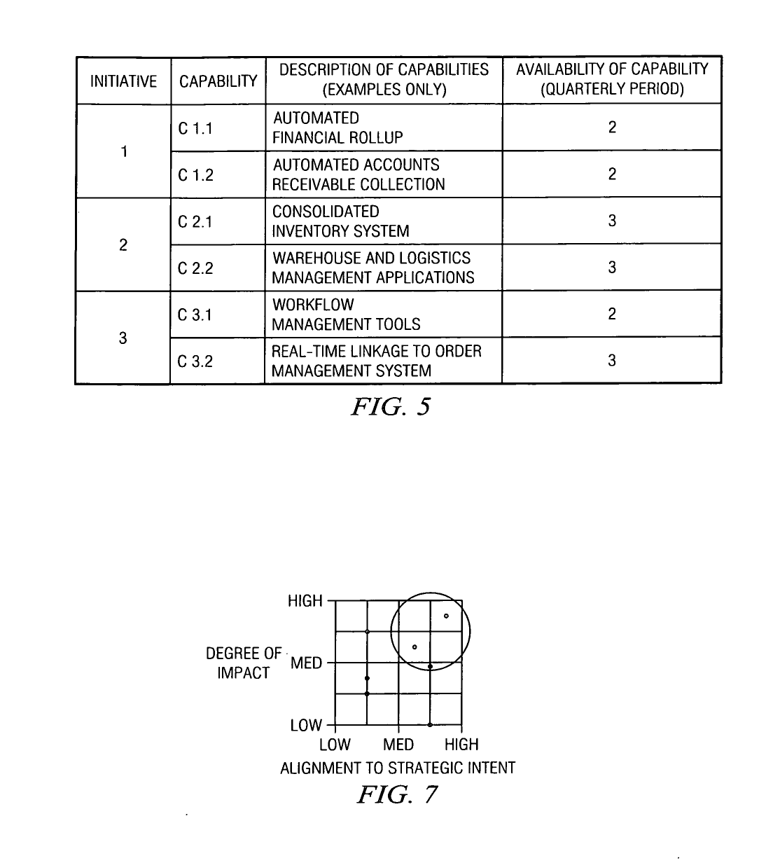

Turning now to FIG. 5, an abbreviated sample of the format for documenting the capabilities of an initiative as disclosed in step 225 of FIG. 2 is provided. The value framework of the present invention views process improvements as the result of new or enhanced capabilities of the solution. It should be communicated to the client how the capabilities that the solution delivers enable process improvements, rather than merely communicating the potential process improvements that would result from the implementation of a proposed solution. Failing to articulate how the process improvements are enabled can make logical estimates of the benefits difficult at best.

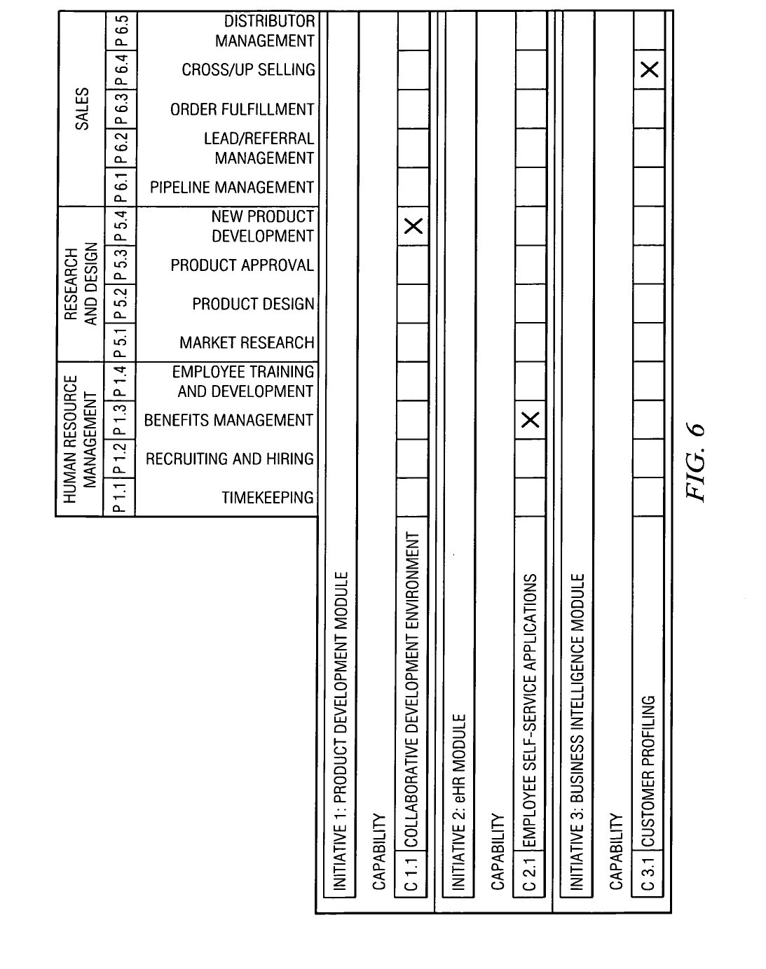

The processes illustrated in FIGS. 6, 7, and 8 are typically performed in a workshop setting with the client. Once the capabilities have been documented, the framework requires that the value model team work with the client to map the linkages between the proposed capabilities and the identified key business processes. In particular, FIG. 6 provides a sample of the structure for documenting the linkages between the capabilities and the key processes to facilitate estimating business process improvements. This first session of the workshop involves starting with listing the appropriate industry process area (and their sub-processes) that are aligned to the client's strategic intent. Client subject matter experts (SMEs) from the various process areas participate in the workshop to determine the linkages. Before any linkages are made, however, the pre-determined list of processes are discussed with the client SMEs to determine if any process areas should be added, eliminated, or revised.

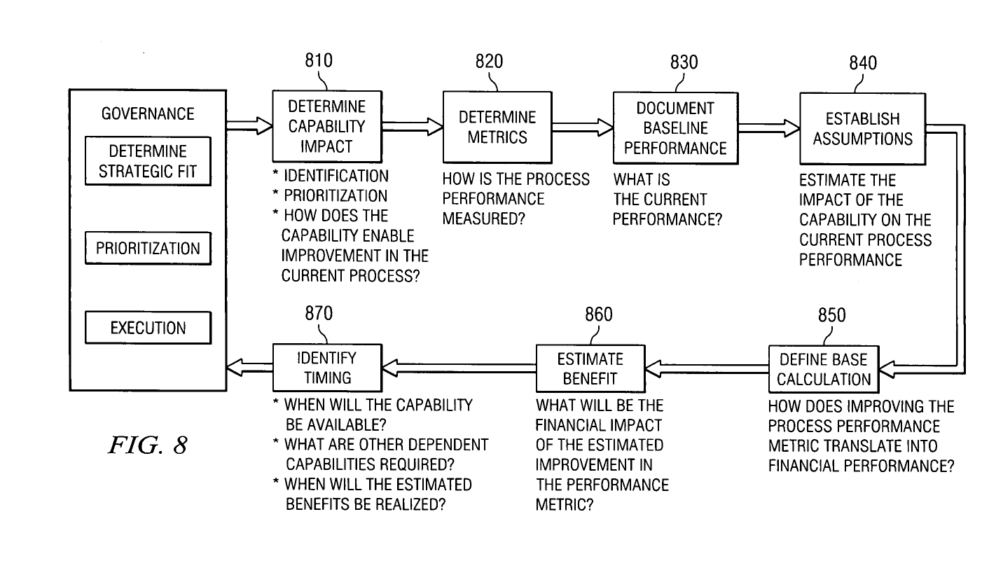

After the processes have been validated, each capability is discussed and the potential impact to the sub-processes documented. At this point, the value model team only determines where potential impacts may occur. Determining how the potential impacts occur and to what extent each capability would impact a certain process will be determined in the second part of the workshop as explained in FIG. 7.

The second part of the workshop involves working with the client SMEs to prioritize the process impacted based on the degree of impact and alignment to the client's strategic intent. FIG. 7 shows a sample output from the workshop where the identified linkages have been prioritized. Once the process impacts have been mapped, a certain subset are chosen for inclusion in the ROI model and business case. Each process impact chosen will be the focal areas for the remaining session of the workshop.

FIG. 8 provides an overview of the process of estimating the potential process improvements. This final session of the workshop involves taking the output of the prioritization activity and completing the first five steps of a seven-step approach to estimating the financial benefits of a proposed solution. At this point in the workshop, the process impacts have been identified and prioritized. The process of estimating the potential process improvements begins by determining the capability impact, as shown in step 810. This first step involves working with the SMEs to determine how the proposed capability will impact the process identified and articulating in simple business terms how the capability would improve the current process.

Next, the metrics and document baseline performance are determined in steps 820 and 830. This involves determining how the process performance is measured and documenting the current performance based on that measurement system or metric. If appropriate benchmark data is readily available and time permits, the process improvement assumptions can be developed and validated during the workshop. In most cases, the completion of step 830 signals the end of the workshop and the information collected and SMEs are consulted offline to complete steps 840 through 870.

In step 840, assumptions regarding process improvement are established to estimate the impact of the capability on the current process performance. ROI models are inherently assumption-driven. Assumptions regarding the estimated process improvement are used to determine the potential financial benefits of a proposed solution. Step 840 involves developing assumptions regarding the anticipated process improvements by leveraging the service provider's historical expertise, using analyst and industry benchmark data, and involving the client in developing the assumptions. The process improvement assumptions developed are a critical element to developing a sound and defensible case. Source data and client validation should be documented in order to achieve the necessary credibility with the client. In addition, a capability can also enable a new process, in which case the approach needs to be modified by estimating future process performance using industry data rather than the improvements to the client's baseline performance.

Steps 850 through 870 in FIG. 8 involve estimating the financial impact of a solution. These steps are included in estimating the financial ROI as included in steps 240 and 245 in FIG. 2. As previously stated, estimating the financial impact of a solution involves understanding how and to what extent that the proposed capabilities would enable business process improvements, based on the theory that only through process improvement can cost efficiencies (process related) and revenue benefits be realized. Understanding the financial impact of any investment requires estimating the timing of potential cost efficiencies, cost takeout, incremental revenue benefits and the required investment. While estimating the potential cost takeout and required investment is relatively straight forward, estimating cost efficiencies and revenue benefits involves completing steps 850 through 870 of the seven-step approach.

In step 850 and 860, the base calculation is defined and the benefits is estimated. After the baseline metric and the current performance process improvement assumptions have been documented, the next step is to determine how improving the process performance drives financial benefits. This involves defining the baseline benefit calculation (step 850) and plugging in the estimated improvement in the process performance metric to calculate the anticipated benefits (step 860).

The final step in the seven-step approach for estimating process improvement as shown in FIG. 8 is to determine the anticipated timing for each benefit associated with a proposed capability (step 870). This step involves documenting when (e.g., quarterly period) the capability driving the benefit is expected to be available and then developing an assumption for when the estimated benefit will begin to be realized. In addition, the value model team must estimate how long each benefit will be realized (i.e., number of periods). Finally, the timing of the benefits may need to be adjusted if the anticipated benefit is dependent on other capabilities or factors.

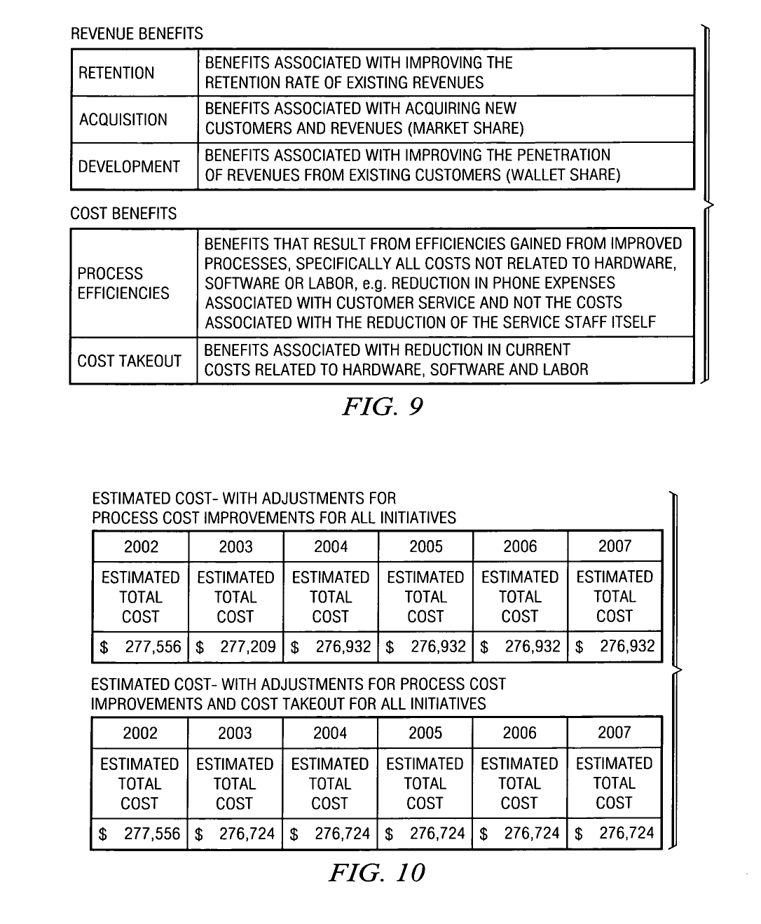

In order to estimate the benefits and return on investment of the proposed solution as illustrated in steps 240 and 245 of FIG. 2, the value model team should first categorize the anticipated benefits as either revenue or cost benefits. FIG. 9 illustrates an example of the specific classification of benefits. Revenue benefits may include three primary categories: benefits achieved from retention, benefits achieved from acquisition, and benefits achieved from development. Cost benefits may include two primary categories; benefits achieved from process efficiencies and those achieved from cost takeout opportunities.

As for cost benefits, FIG. 10 provides a closer look at the ROI model and the generation of estimated cost benefits. FIG. 10 illustrates the estimated cost benefits for both adjustments for process cost improvements and adjustments for process cost improvements and cost takeout. The ROI model starts with the current as-is operating costs and modifies the anticipated future costs by first reducing the cost by the process efficiency benefits. This component is calculated by summing up the quarterly benefits and reducing the future operating costs going forward. The model then requires the team to estimate the cost benefits associated with anticipated reduction in software, hardware and labor. The yearly hard number reduction is then used to reduce the to-be operating costs previously adjusted for process efficiencies.

The ROI model also allows the team to break out the estimated benefits into two important views: a solution component/initiative (for opportunities that present multiple initiatives), and the client's line of business. The model allows the team to develop these different views but requires that the estimated impact of the process improvements and the anticipated cost takeout are calculated for each line of business and the enabling capabilities of each initiative clearly differentiated. The effort to break out the benefits by line of business and for multiple initiatives adds complexity to the process. As a result, multiple client workshops as well as additional development time will likely be required.

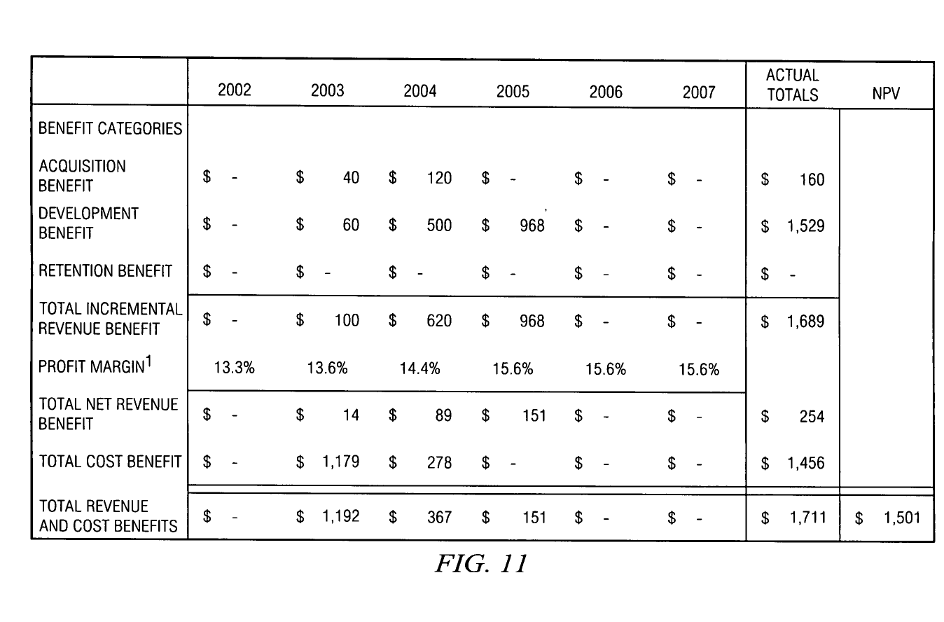

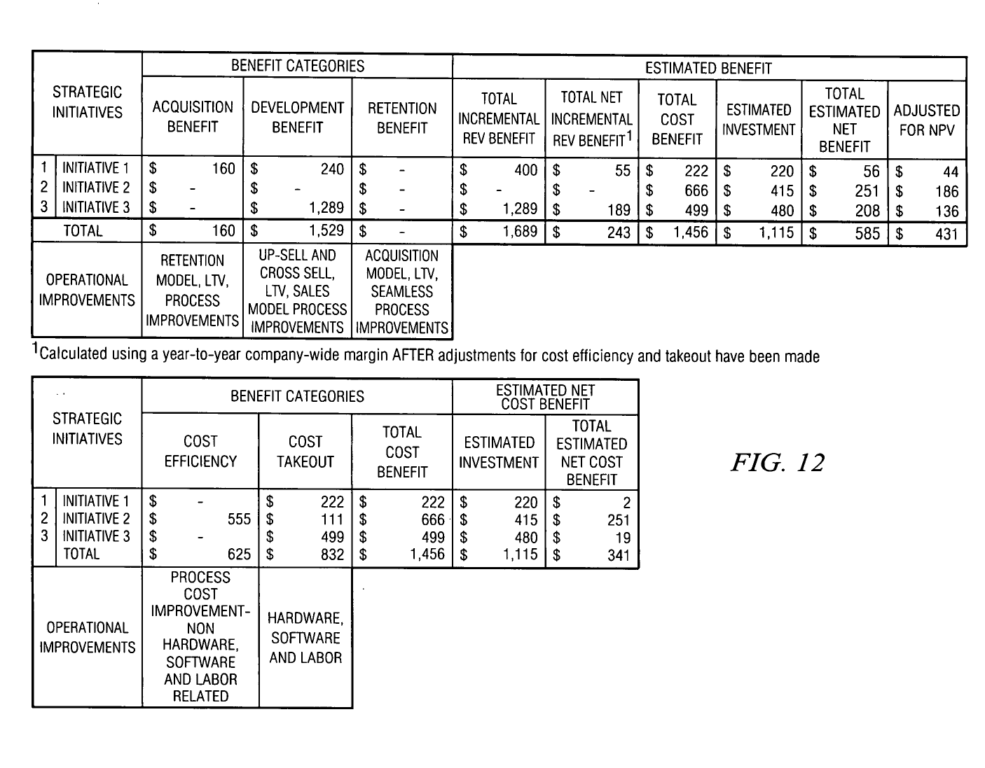

As for net revenue benefits, the estimated cost benefits are used to adjust the anticipated profit margin to calculate the net revenue benefits. FIGS. 11 and 12 illustrate examples of the benefit summary and the benefits by initiative and category from the ROI model. As stated before, the anticipated revenue benefits are classified into different categories, including retention, acquisition, and development. The estimated benefits are calculated by uplifting the as-is revenues and providing a gross revenue benefit.

At this point, the ROI model then takes a somewhat modified approach to calculating the net revenue, or free cash flow, that is expected to result. Instead of developing a detailed and often tedious cash flow statement for the client, the ROI model adjusts the as-is profit margin based on the anticipated cost benefits. This adjusted profit margin is then used to estimate the net benefits associated with the estimated gross revenue benefits.

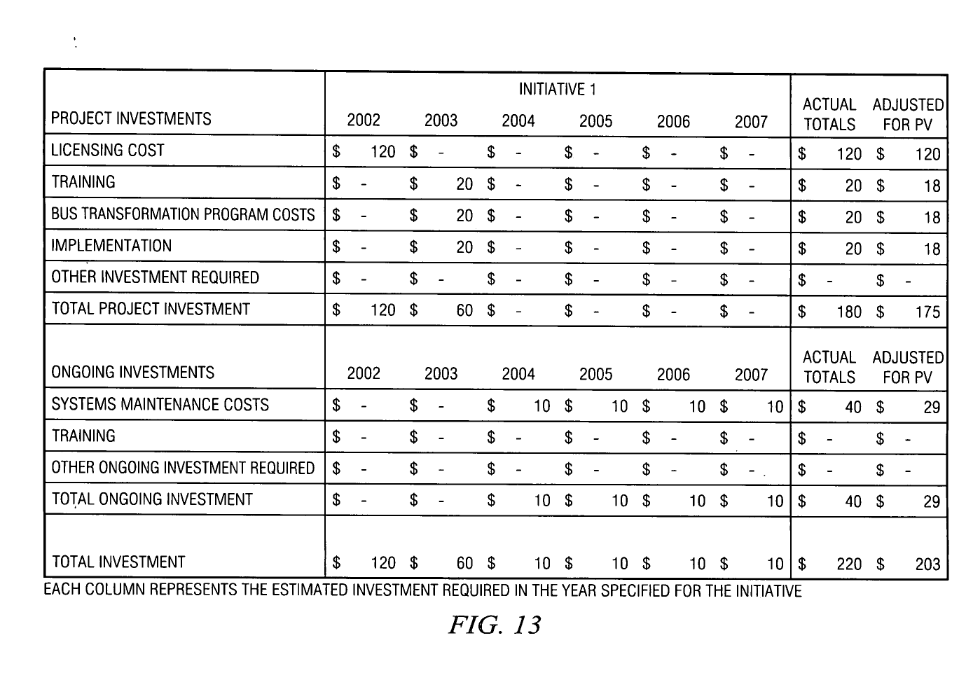

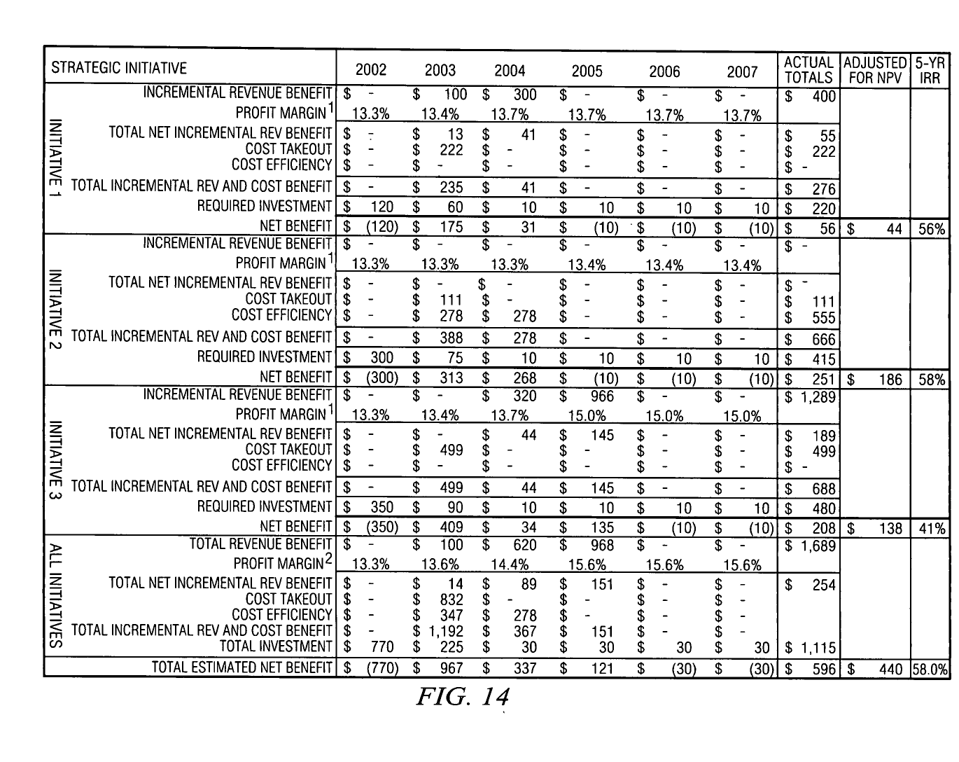

It is this net incremental revenue benefit plus the cost benefits, estimated over a period of time that is considered to be the anticipated return when calculating the ROI for a proposed initiative. As in the cost benefit component, the model allows the revenue benefits to be broken out by line of business and by initiative. FIG. 13 provides a closer look at step 235 in FIG. 2. FIG. 13 illustrates the task of estimating the investment required for a proposed solution. This step requires estimating both the anticipated upfront costs and ongoing periodical costs associated with the implementation of a solution. The amount and timing of the investment will differ on a project-by-project basis, but many of investment categories will often be the same. It is preferable to incorporate any opportunity or performance costs associated with the proposed changes in addition to the ‘standard’ costs of software, hardware, services, and training. If the client requires that the value proposition provide views of the estimated return by initiative and line of business, then the investment data will also need to provide this level of detail.

Once the net revenue and cost benefits have been estimated, the return on investment can be estimated as illustrated in step 245 in FIG. 2. Calculating the return on investment of a proposed solution requires assessing the value of the anticipated net benefit associated with an investment in an initiative. For example, the rate of return is calculated using the estimated net cash flow over a serious of time. The cash flows in future periods are adjusted for the time value of money (present value) using the client's discount rate (cost of capital).

The value framework and ROI Model provide a roadmap for translating the proposed capabilities enabled by a solution into the impact on the client's processes and ultimately the potential quantifiable benefits (incremental revenues and cost benefits). The ROI model takes the anticipated net benefits and incorporates the required investment over a series of time to calculate the expected return on investment. FIG. 14 shows an example of the benefit assessment by initiative that can be generated for a client from the ROI model. Consistent with the other components of the framework and model, the output in FIG. 14 can be displayed for each line of business if the data is available and development time permits.

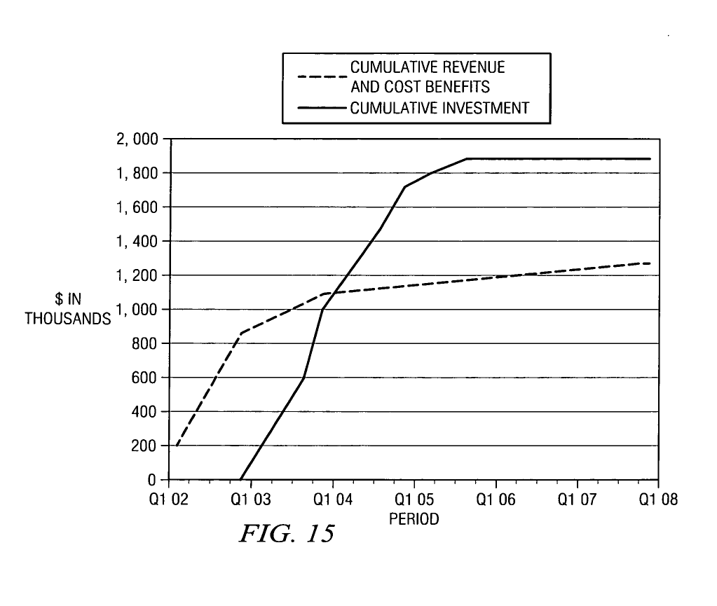

FIG. 15 shows a sample break-even graph generated by the ROI model that provides the client with an understanding of when the estimated cumulative benefits will begin to outpace the investment required. A break-even graph and analysis can also be developed for each initiative or solution component.

Although the value framework includes reference to the alignment of the industry drivers and the client's strategic intent to the enabling capabilities of the solution, it is not intended to replace a strategic engagement where these drivers and the subsequent strategic recommendations are developed. The intent of the value framework approach is to use existing strategic recommendations as input into a framework that takes a process improvement view to estimate the financial impact of a solution.

In addition to understanding the client's strategic intent, developing a value proposition for a solution requires understanding the enabling capabilities of the proposed initiative(s). The value framework estimates the financial impact of a solution and assumes that the engagement team has already proposed a solution that details the capabilities that will help the client to achieve their strategic objectives. If the client's strategic intent is not clear, or the capabilities not well understood, it is the responsibility of the engagement team to further develop the opportunity before positioning or attempting to deliver a value proposition.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for developing a client value proposition, wherein the client value proposition provides a proposed solution enabling a client to achieve its business objectives, comprising:
performing a strategic assessment of the industry drivers to determine a client's strategic intent;
identifying business process areas aligned to the client's strategic intent;
determining required capabilities of the proposed solution;
estimating business processes improvements by linking proposed solutions to business benefits that the proposed solutions provide;
estimating a financial impact the proposed solution will have on the client; and
displaying the estimated business processes improvements and estimated financial impact on an output device.

2. The method of claim 1, wherein the strategic assessment includes generating an understanding of factors and trends that drive a client's industry to determine the client's strategic intent.

3. The method of claim 1, wherein the strategic assessment includes understanding how the client is positioned relative to its industry and peers.

4. The method of claim 1, wherein identifying business process areas includes understanding a client's industry business architecture, determining existing processes where improvements would result in desired results, and identifying new processes that may facilitate achieving desired results.

5. The method of claim 4, wherein identifying business process areas includes documenting how the improved existing processes or new processes impact the various processes in a client's industry.

6. The method of claim 5, wherein the documenting step includes documenting key performance metrics, industry/peer benchmark data, and source of the industry/peer benchmark data for each of the identified business process areas.

7. The method of claim 1, wherein determining the required capabilities of the proposed solution includes documenting the capabilities of the proposed solution.

8. The method of claim 1, wherein estimating the impact of process improvements includes identifying linkages between the proposed solution and the business process areas, prioritizing the identified linkages based on degree of impact and alignment to the client's strategic intent, and estimating potential process improvements.

9. The method of claim 1, wherein estimating the financial impact of the proposed solution includes estimating a cost benefit, a net revenue benefit, a required investment, and a return on investment.

10. A data processing system for developing a client value proposition, wherein the client value proposition provides a proposed solution enabling a client to achieve its business objectives, comprising:
performing means for performing a strategic assessment of the industry drivers to determine a client's strategic intent;
identifying means for identifying business process areas aligned to the client's strategic intent;
determining means for determining required capabilities of the proposed solution;
first estimating means for estimating business processes improvements by linking proposed solutions to business benefits that the proposed solutions provide;
second estimating means for estimating a financial impact the proposed solution will have on the client; and
displaying means for displaying the estimated business processes improvements and estimated financial impact on an output device.

11. The data processing system of claim 10, wherein the strategic assessment includes generating an understanding of factors and trends that drive a client's industry to determine the client's strategic intent.

12. The data processing system of claim 10, wherein the strategic assessment includes understanding how the client is positioned relative to its industry and peers.

13. The data processing system of claim 10, wherein identifying business process areas includes understanding a client's industry business architecture, determining existing processes where improvements would result in desired results, and identifying new processes that may facilitate achieving desired results.

14. The data processing system of claim 13, wherein identifying business process areas includes documenting how the improved existing processes or new processes impact the various processes in a client's industry.

15. The data processing system of claim 14, wherein the documenting step includes documenting key performance metrics, industry/peer benchmark data, and source of the industry/peer benchmark data for each of the identified business process areas.

16. The data processing system of claim 10, wherein determining the required capabilities of the proposed solution includes documenting the capabilities of the proposed solution.

17. The data processing system of claim 10, wherein estimating the impact of process improvements includes identifying linkages between the proposed solution and the business process areas, prioritizing the identified linkages based on degree of impact and alignment to the client's strategic intent, and estimating potential process improvements.

18. The data processing system of claim 10, wherein estimating the financial impact of the proposed solution includes estimating a cost benefit, a net revenue benefit, a required investment, and a return on investment.

19. A computer program product in a computer readable medium for developing a client value proposition, wherein the client value proposition provides a proposed solution enabling a client to achieve its business objectives, comprising:
first instructions for performing a strategic assessment of the industry drivers to determine a client's strategic intent;
second instructions for identifying business process areas aligned to the client's strategic intent;
third instructions for determining required capabilities of the proposed solution;
fourth instructions for estimating business processes improvements by linking proposed solutions to business benefits that the proposed solutions provide;
fifth instructions for estimating a financial impact the proposed solution will have on the client; and
sixth instructions for displaying the estimated business processes improvements and estimated financial impact on an output device.

20. The computer program product of claim 19, wherein the strategic assessment includes generating an understanding of factors and trends that drive a client's industry to determine the client's strategic intent.

21. The computer program product of claim 19, wherein the strategic assessment includes understanding how the client is positioned relative to its industry and peers.

22. The computer program product of claim 19, wherein identifying business process areas includes understanding a client's industry business architecture, determining existing processes where improvements would result in desired results, and identifying new processes that may facilitate achieving desired results.

23. The computer program product of claim 22, wherein identifying business process areas includes documenting how the improved existing processes or new processes impact the various processes in a client's industry.

24. The computer program product of claim 23, wherein the documenting step includes documenting key performance metrics, industry/peer benchmark data, and source of the industry/peer benchmark data for each of the identified business process areas.

25. The computer program product of claim 19, wherein determining the required capabilities of the proposed solution includes documenting the capabilities of the proposed solution.

26. The computer program product of claim 19, wherein estimating the impact of process improvements includes identifying linkages between the proposed solution and the business process areas, prioritizing the identified linkages based on degree of impact and alignment to the client's strategic intent, and estimating potential process improvements.

27. The computer program product of claim 19, wherein estimating the financial impact of the proposed solution includes estimating a cost benefit, a net revenue benefit, a required investment, and a return on investment.
